(19) United States
(12) Patent Application Publication
(10) Pub. No.: US 2023/0406993 A1
(43) Pub. Date: Dec. 21, 2023

(54) TWO-COMPONENT POLYURETHANE FILLER HAVING AN ADJUSTABLE POT LIFE

(71) Applicant: SIKA TECHNOLOGY AG, Baar (CH)

(72) Inventors: Semjon ROTH, Baden (CH); Stefan MEISTER, St. Lorenzen im Mürztal (AT); Antonio CORSARO, Regensdorf (CH); Fabien CHOFFAT, Rüttenen (CH)

(73) Assignee: SIKA TECHNOLOGY AG, Baar (CH)

(21) Appl. No.: 18/035,647

(22) PCT Filed: Feb. 1, 2022
(86) PCT No.: PCT/EP2022/052310

§ 371 Date: May 5, 2023

(30) Foreign Application Priority Data
Feb. 2, 2021 (EP) 21154812.8

(51) Int. Cl. C08G 18/48; C08K 7/28; C08G 18/22; C08G 18/32; C08G 18/38; C08G 18/66; C08G 18/76

(52) U.S. Cl. CPC C08G 18/4816; C08K 7/28; C08G 18/227; C08G 18/3206; C08G 18/3876; C08G 18/4841; C08G 18/4829; C08G 18/6674; C08G 18/7671

(57) ABSTRACT

The present invention relates to a polyol composition consisting of a first component and a second component, wherein the first component contains a polyol having had OH functionality in the range from 1.5 to 4 and an average molecular weight in the range from 250 to 15'000 g/mol, a diol having at least two hydroxyl groups joined via a C2 to C9 carbon chain, and a compound having at least one thiol group. In addition, one of the two components additionally comprises at least one metal catalyst for the reaction of hydroxyl groups and isocyanate groups which is capable of forming thio complexes, and where the molar ratio of all NCO groups of the polyisocyanates I to all OH groups of the polyols=0.9:1-1.4:1, especially 1.05:1-1.3:1, and where the composition contains, in at least one of the two components, between 3% and 25% by weight, based on the overall composition, of at least one type of microscopic hollow beads, wherein the microscopic hollow beads have a compressive strength, measured to ASTM D3102-72, of at least 10 MPa and a density of at least 0.2 kg/L, and wherein the composition contains, in at least one of the two components, between 2.5% and 7.5% by weight, based on the overall composition, of at least one desiccant, wherein the desiccant is an aluminosilicate.

Such a composition permits arbitrary adjustment of the open time within particular limits, and enables achievement of long open times with subsequent very rapid curing of the composition. The composition of the invention has excellent strength and hardness, and is grindable without difficulty. The composition of the invention is particularly suitable as filling compound, especially for wood.

### TECHNICAL FIELD

The invention relates to the field of two-component polyurethane compositions and to the use thereof as grindable filling compounds, and to a method of filling cavities, holes or gaps, especially in wood, with such a polyurethane composition.

### PRIOR ART

Wood is a popular building and manufacturing material and even nowadays has a variety of uses, for example in furniture making or as floors in interiors. Specifically in such applications, it is desirable for wooden boards have a smooth surface. However, wood is a natural material and, as such, two-dimensional wooden boards or planks, as used for floors for instance, will regularly have defects such as fissures, branching gaps and holes, and similar recesses at the surface. These defects must be leveled, i.e. bonded, filled or sealed, in order to create a surface suitable for final processing. This final processing usually comprises grinding or sanding, followed by finishing and further treatments. Branch areas in particular are problematic in the processing of surfaces. Branch slices either have a tendency to fall out, which gives rise to large holes, or frequently have star-shaped drying shrinkage fissures.

There are various proposed solutions for establishment of a uniform surface without defects in the wood. They range from cutting-out of the defect sites or to the breaking-out of the branch slices and insertion of blanks up to the gluing of branch slices.

All these methods are time-consuming and often inefficient in relation to material utilization.

Therefore, methods have been developed in which a suitable filling compound is introduced into the defect sites, which is then cured and ground with the wood. For example, DE 102 30 574 A1 teaches a thermoplastic filling compound which is introduced into the defect sites and cures rapidly. A disadvantage here, however, is that the thermoplastic filling compound must be distinctly heated, which makes the process laborious and can cause thermal stress to the wood.

It is generally desirable for the filling compound to be introduced to have good adhesion to the types of wood that are used in this market, and to have similar hardness to the wood, but at the same time a certain elasticity in order to be able to follow the natural movements (such as contractions) of the wood substrate, without forming fissures or the like.

For that reason, polyurethane compositions have indeed been developed for that purpose. Polyurethane compositions are known to have good adhesion to wood and can be formulated with a broad profile of properties, and the establishment of a suitable hardness and elasticity, but also color, is usually satisfactory. Two-component polyurethane compositions in particular are suitable for this purpose.

These have the advantage over one-component compositions that they cure rapidly after mixing and can therefore be processed further even after a short time, i.e. ground for example.

On the other hand, however, it is always necessary to enter into compromises with two-component polyurethane compositions. For use of two-component polyurethane compositions as filling compounds, it would generally be desirable to be able to combine a sufficiently long processing time (pot life) of the mixed composition without an excessively rapid rise in viscosity as a result of the commencement of curing, but with subsequently very rapid curing after processing and extremely rapid development of strength. However, this is barely achievable with customary two-component compositions. Either the pot life is very short in the case of compositions that cure rapidly and develop strength quickly, or else curing and hardening are slow when processing compositions that have a long pot life.

For industrial processing with rapid cycle times, it would be desirable if pot life were to be sufficiently long and ideally even adjustable for optimal processing of the as yet uncured filling compound, without any significant rise in viscosity during that period, but then if curing after the end of processing were to be very rapid, with immediate grindability of the cured compound. This has not yet been achievable with the polyurethane-based filling compounds produced to date.

DE 198 58 818 A1 teaches, for example, aqueous filling compounds based on two-component polyurethane compositions. These have good grindability, but require a considerable wait time until grindability after curing, especially when the pot life has been set to be long enough for good processibility.

WO 98/15586 A1, as another example, likewise teaches a two-component polyurethane filling compound for the smoothing of wood. These have high viscosity and/or a rapid rise in viscosity after application, such that the compound does not run off even vertical surfaces in an uncontrolled manner. However, it is difficult to completely fill all cavities with such a high-viscosity or rapidly curing filling compound, which can lead to acoustic problems in extreme cases in the case of floor coverings, for example.

There is therefore a desire for filling compounds based on two-component polyurethane compositions that can be processed conveniently during a sufficiently long pot life without any rising viscosity, but which, after application, irrespective of layer thickness, cure rapidly and can be ground or sanded within a very short time. As well as good grindability, they should also have sufficiently high Shore D hardness, i.e., for example, of 60 or more. It would additionally be desirable for the pot life of such a composition to be adjustable for the desired use.

### SUMMARY OF THE INVENTION

It is therefore an object of the present invention to provide a filling compound based on a two-component polyurethane composition that cures very rapidly to form a grindable compound with sufficiently high hardness that has excellent mechanical properties and is suitable as wood filling compound, but at the same time has a sufficiently long pot life adjustable within certain limits, allowing it to be processed without difficulty.

This object is surprisingly achieved with the polyurethane composition of the invention as claimed in claim 1. The composition comprises at least one polyol, a short-chain diol, and also a compound having at least one thiol group in the first component and a high content of polyisocyanate in the second component. For curing the composition, the composition further contains a metal catalyst that is able to form thio complexes, the ratio of thiol groups to metal atoms in the composition being fixed. Furthermore, the composition contains microscopic hollow beads and an aluminosilicate-based desiccant. After mixing the components and after an adequately long pot life that is adjustable within certain limits, it cures very rapidly and achieves very good mechanical values after just a short time, for example a few minutes to hours, and can be processed further without difficulty. The composition has very high hardness and good elasticity in the cured state, and has excellent grindability.

Further aspects of the invention are the subject of further independent claims. Particularly preferred embodiments of the invention are the subject of the dependent claims.

### WAYS OF EXECUTING THE INVENTION

The present invention relates to a polyurethane composition consisting of a first and a second component; wherein
the first component A comprises
   comprises at least one polyol A1 having an OH functionality in the range from 1.5 to 4 and a mean molecular weight in the range from 250 to 15 000 g/mol, and
   at least one diol A2 having two hydroxyl groups joined via a C2 to C9 carbon chain, and
   at least one compound T that has at least one thiol group; and
the second component B comprises
   at least one polyisocyanate I;
wherein one of the components additionally comprises at least one metal catalyst K for the reaction of hydroxyl groups and isocyanate groups that is able to form thio complexes;
and wherein the molar ratio of all the thiol groups in the at least one compound T to all metal atoms in the at least one metal catalyst K is between 1:1 and 250:1;
and wherein the molar ratio of all NCO groups in the polyisocyanates I to all OH groups in the polyols A1 and A2=0.9:1-1.5:1, especially 1.05:1-1.3:1;
and wherein the composition, in at least one of the two components, contains between 3% and 25% by weight, based on the overall composition, of at least one type of hollow microspheres H, where the hollow microspheres H have a compressive strength measured to ASTM D3102-72 of at least 10 MPa and a density of at least 0.2 kg/L;
and wherein the composition, in at least one of the two components, contains between 2.5% and 7.5% by weight, based on the overall composition, of at least one desiccant D, where the desiccant D is an aluminosilicate.

The prefix “poly” in substance names such as “polyol”, “polyisocyanate”, “polyether” or “polyamine” in the present document indicates that the respective substance, in a formal sense, contains more than one of the functional groups that occur in its name per molecule.

The term “polymer” in the present document firstly encompasses a collective of macromolecules that are chemically uniform but differ in the degree of polymerization, molar mass, and chain length, said collective having been produced by a “poly” reaction (polymerization, polyaddition, polycondensation).

The term also encompasses derivatives of such a collective of macromolecules from “poly” reactions, i.e. compounds obtained by reactions, for example additions or substitutions, of functional groups in defined macromolecules and which may be chemically uniform or chemically nonuniform. The term further encompasses so-called prepolymers too, i.e. reactive oligomeric initial adducts, the functional groups of which are involved in the formation of macromolecules.

The term “polyurethane polymer” encompasses all polymers produced according to the so-called diisocyanate polyaddition process. This also includes polymers that are virtually or completely free of urethane groups. Examples of polyurethane polymers are polyether polyurethanes, polyester polyurethanes, polyether polyureas, polyureas, polyester polyureas, polyisocyanurates, and polycarbodiimides.

“Molecular weight” is in the present document understood to mean the molar mass (in grams per mole) of a molecule or a molecule residue. “Average molecular weight” refers to the number average Mn of a polydisperse mixture of oligomeric or polymeric molecules or molecule residues, which is typically determined by gel-permeation chromatography (GPC) against polystyrene as standard. In the present document, “room temperature” refers to a temperature of 23° C. Percent by weight values, abbreviated to % by weight, refer to the proportions by mass of a constituent in a composition based on the overall composition, unless otherwise stated. The terms “mass” and “weight” are used synonymously in the present document.

A “primary hydroxyl group” refers to an OH group attached to a carbon atom having two hydrogens.

“Pot life” refers in this document to the time within which, after mixing the two components, the polyurethane composition can be processed before the viscosity resulting from the progression of the crosslinking reaction has become too high for further processing.

The term “strength” in the present document refers to the strength of the cured composition, with strength meaning in particular the tensile strength and modulus of elasticity, particularly within the 0.05% to 0.25% region of elongation.

In the present document, “room temperature” refers to a temperature of 23° C.

A substance or a composition is described as “storage-stable” or “storable” if it can be stored at room temperature in a suitable container for a relatively long period, typically at least 3 months up to 6 months or longer, without this storage resulting in any change in its application or use properties, especially in the viscosity and crosslinking rate, to an extent relevant to the use thereof.

All industry standards and norms mentioned in this document relate to the versions valid at the date of first filing.

The first component A comprises firstly at least one polyol A1 having an OH functionality in the range from 1.5 to 4 and an average molecular weight in the range from 250 to 15 000 g/mol.

Suitable polyols A1 are in principle all polyols currently used in the production of polyurethane polymers. Particularly suitable are polyether polyols, polyester polyols, poly(meth)acrylate polyols, polybutadiene polyols, polycarbonate polyols, and also mixtures of these polyols.

Suitable polyether polyols, also known as polyoxyalkylene polyols or oligoetherols, are in particular those that are polymerization products of ethylene oxide, 1,2-propylene oxide, 1,2- or 2,3-butylene oxide, oxetane, tetrahydrofuran, propane-1,3-diol or mixtures thereof, optionally polymerized with the aid of a starter molecule having two or more active hydrogen atoms such as water, ammonia or compounds having a plurality of OH or NH groups, for example ethane-1,2-diol, propane-1,2-diol and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3-dimethanol and -1,4-dimethanol, bisphenol A, hydrogenated bisphenol A, 1,1,1-trimethylolethane, 1,1,1-trimethylolpropane, glycerol, aniline, and also mixtures of the recited compounds.

It is possible to use either polyoxyalkylene polyols having a low degree of unsaturation (measured in accordance with ASTM D-2849-69 and expressed in milliequivalents of unsaturation per gram of polyol (mEq/g)), produced for example using so-called double metal cyanide complex catalysts (DMC catalysts), or polyoxyalkylene polyols having a relatively high degree of unsaturation, produced for example using anionic catalysts such as NaOH, KOH, CsOH or alkali metal alkoxides.

Particularly suitable are polyoxyethylene polyols and polyoxypropylene polyols, in particular polyoxyethylene diols, polyoxypropylene diols, polyoxyethylene triols, and polyoxypropylene triols.

Especially suitable are polyoxyalkylene diols or polyoxyalkylene triols having a degree of unsaturation lower than 0.02 meq/g and having a molecular weight within a range from 400 to 15'000 g/mol, as are polyoxyethylene diols, polyoxyethylene triols, polyoxypropylene diols, and polyoxypropylene triols having a molecular weight of 400 to 15'000 g/mol.

Likewise particularly suitable are so-called ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are at the end of the polypropoxylation reaction further alkoxylated with ethylene oxide and thus have primary hydroxyl groups. Preference in this case is given to polyoxypropylene polyoxyethylene diols and polyoxypropylene polyoxyethylene triols.

Also suitable are hydroxyl-terminated polybutadiene polyols, for example those produced by polymerization of 1,3-butadiene and allyl alcohol or by oxidation of polybutadiene and also the hydrogenation products thereof.

Also suitable are styrene-acrylonitrile grafted polyether polyols such as those commercially available for example under the trade name Lupranol® from Elastogran GmbH, Germany.

Suitable polyester polyols include in particular polyesters that bear at least two hydroxyl groups and are produced by known processes, especially polycondensation of hydroxycarboxylic acids or polycondensation of aliphatic and/or aromatic polycarboxylic acids with dihydric or polyhydric alcohols. Especially suitable are polyester polyols produced from dihydric to trihydric alcohols such as ethane-1,2-diol, diethylene glycol, propane-1,2-diol, dipropylene glycol, butane-1,4-diol, pentane-1,5-diol, hexane-1,6-diol, neopentyl glycol, 3-methylpentane-1,5-diol (MPD), nonane-1,9-diol (ND), glycerol, 1,1,1-trimethylolpropane or mixtures of the abovementioned alcohols with organic dicarboxylic acids or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the abovementioned acids, as are polyester polyols formed from lactones such as ε-caprolactone.

Particularly suitable are polyester diols, in particular those produced from adipic acid, azelaic acid, sebacic acid, dodecanedicarboxylic acid, dimer fatty acid, phthalic acid, isophthalic acid and terephthalic acid as the dicarboxylic acid or from lactones such as ε-caprolactone and from ethylene glycol, diethylene glycol, neopentyl glycol, butane-1,4-diol, hexane-1,6-diol, dimer fatty acid diol, and cyclohexane-1,4-dimethanol as the dihydric alcohol.

Suitable polycarbonate polyols include in particular those obtainable by reaction for example of the abovementioned alcohols used to form the polyester polyols with dialkyl carbonates such as dimethyl carbonate, diaryl carbonates such as diphenyl carbonate, or phosgene. Likewise suitable are polycarbonates obtainable from the copolymerization of CO₂ with epoxides such as ethylene oxide and propylene oxide. Polycarbonate diols, in particular amorphous polycarbonate diols, are particularly suitable.

Further suitable polyols are poly(meth)acrylate polyols.

Also suitable are polyhydroxy-functional fats and oils, for example natural fats and oils, in particular castor oil, or so-called oleochemical polyols obtained by chemical modification of natural fats and oils, the epoxy polyesters or epoxy polyethers obtained for example by epoxidation of unsaturated oils and subsequent ring opening with carboxylic acids or alcohols respectively, or polyols obtained by hydroformylation and hydrogenation of unsaturated oils. Also suitable are polyols obtained from natural fats and oils by degradation processes such as alcoholysis or ozonolysis and subsequent chemical linking, for example by transesterification or dimerization, of the thus obtained degradation products or derivatives thereof. Suitable breakdown products of natural fats and oils are in particular fatty acids and fatty alcohols and also fatty acid esters, in particular the methyl esters (FAME), which can be derivatized to hydroxy fatty acid esters, for example by hydroformylation and hydrogenation.

Likewise suitable are, in addition, polyhydrocarbon polyols, also referred to as oligohydrocarbonols, for example polyhydroxy-functional ethylene-propylene, ethylene-butylene or ethylene-propylene-diene copolymers, for example those produced by Kraton Polymers, USA, or polyhydroxy-functional copolymers of dienes, such as 1,3-butadiene or diene mixtures, and vinyl monomers such as styrene, acrylonitrile or isobutylene, or polyhydroxy-functional polybutadiene polyols, for example those which are produced by copolymerization of 1,3-butadiene and allyl alcohol and which may also be hydrogenated.

Also suitable are polyhydroxy-functional acrylonitrile/butadiene copolymers, such as those that can be produced from epoxides or amino alcohols and carboxyl-terminated acrylonitrile/butadiene copolymers, which are commercially available under the name Hypro® (formerly Hycar®) CTBN from Emerald Performance Materials, LLC, USA.

All the recited polyols have an average molecular weight from 250 to 15'000 g/mol, in particular from 400 to 10'000 g/mol, preferably from 1000 to 8000 g/mol, and an average OH functionality in the range from 1.5 to 4, preferably 1.7 to 3. However, it is entirely possible for the composition to also include proportions of monools (polymers having only one hydroxyl group).

Particularly suitable polyols are polyester polyols and polyether polyols, in particular polyoxyethylene polyol, polyoxypropylene polyol, and polyoxypropylene polyoxyethylene polyol, preferably polyoxyethylene diol, polyoxypropylene diol, polyoxyethylene triol, polyoxypropylene triol, polyoxypropylene polyoxyethylene diol, and polyoxypropylene polyoxyethylene triol.

The first component A further comprises at least one diol A2 having two hydroxyl groups that are linked via a C2 to C9 carbon chain.

Suitable as diol A2 are linear or branched alkylene diols having two primary or secondary hydroxyl groups, alkylene diols having one primary and one secondary hydroxyl group, and cycloaliphatic diols.

The diol A2 is preferably a linear aliphatic diol having two primary hydroxyl groups that are linked via a C4 to C9 carbon chain. Such a diol has the advantage of yielding elastic polyurethanes having particularly high moduli of elasticity in the low elongation range, for example between 0 and 5%, which is advantageous for wood filling compounds in particular.

In particular, the diol A2 is selected from the group consisting of ethylene glycol, propane-1,3-diol, butane-1,4-diol, pentane-1,5-diol, hexane-1,6-diol, heptane-1,7-diol, octane-1,8-diol, nonane-1,9-diol, butane-1,3-diol, butane-2,3-diol, 2-methylpropane-1,3-diol, pentane-1,2-diol, pentane-2,4-diol, 2-methylbutane-1,4-diol, 2,2-dimethylpropane-1,3-diol (neopentyl glycol), hexane-1,2-diol, butane-1.4-diol, 3-methylpentane-1,5-diol, octane-1,2-diol, octane-3,6-diol, 2-ethylhexane-1,3-diol, 2,2,4-trimethylpentane-1,3-diol, 2-butyl-2-ethylpropane-1,3-diol, 2,7-dimethyloctane-3,6-diol, cyclohexane-1,4-diol, cyclohexane-1,3-dimethanol and cyclohexane-1,4-dimethanol.

The diol A2 is more preferably selected from the group consisting of butane-1,4-diol, pentane-1,5-diol, hexane-1,6-diol, heptane-1,7-diol, octane-1,8-diol, and nonane-1,9-diol.

The diol A2 is most preferably selected from the group consisting of butane-1,4-diol, pentane-1,5-diol, hexane-1,6-diol, and nonane-1,9-diol. These diols are commercially readily available and provide polyurethanes having particularly high moduli of elasticity at low elongation when cured.

The first component A preferably comprises between 5 and 25% by weight, more preferably 10 to 20% by weight, of diol A2.

In addition to these recited polyols A1 and A2, it is possible to include small amounts of further low-molecular-weight dihydric or polyhydric alcohols such as diethylene glycol, triethylene glycol, the isomeric dipropylene glycols and tripropylene glycols, the isomeric decanediols and undecanediols, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low-molecular-weight alkoxylation products of the abovementioned dihydric and polyhydric alcohols, and also mixtures of the abovementioned alcohols. In addition, polyols containing other heteroatoms, for example methyldiethanolamine or thiodiglycol, may also be present.

The first component A further comprises at least one compound T that has at least one thiol group. Suitable are all compounds having at least one thiol or mercapto group that are able to be formulated into the composition of the invention. A thiol group is understood here as meaning an —SH group that is attached to an organic radical, for example an aliphatic, cycloaliphatic or aromatic carbon radical.

Preference is given to compounds having 1 to 6, especially 1 to 4, most preferably 1 or 2 thiol groups. Compounds having a thiol group have the advantage that they do not form complexes with the metal catalyst K, which tend to be sparingly soluble, and that the pot life can be adjusted particularly precisely. Compounds having two thiol groups have the advantage that the mechanical properties of the composition when cured are improved.

Examples of suitable compounds T having a thiol group are 3-mercaptopropyltrimethoxysilane, 3-mercaptopropyltriethoxysilane, 3-mercaptopropane-1,2-diol, 2-mercaptotoluimidazole or 2-mercaptobenzothiazole.

Examples of suitable compounds T having more than one thiol group are 1,8-dimercapto-3,6-dioxaoctane, ethylene glycol di(3-mercaptopropionate), ethylene glycol dimercaptoacetate, dipentaerythritol hexa(3-mercaptopropionate), 2,3-dimercapto-1,3,4-thiadiazole or pentaerythritol tetrakis(3-mercaptopropionate).

The compound T is preferably selected from the group consisting of 1,8-dimercapto-3,6-dioxaoctane, ethylene glycol di(3-mercaptopropionate), ethylene glycol dimercaptoacetate, dipentaerythritol hexa(3-mercaptopropionate), and 3-mercaptopropyl trimethoxysilane.

Component A, based on component A, preferably contains 0.25% to 5% by weight, preferably 1% to 3% by weight, especially 1.5% to 2% by weight, of the compound T having at least one thiol group.

The molar ratio of all the thiol groups in the at least one compound T to all metal atoms in the at least one metal catalyst K must be between 1:1 and 250:1. It is preferably between 2:1 and 150:1, especially between 5:1 and 100:1. This quantitative ratio allows the pot life to be adjusted, specifically within the intrinsic limits of the particular composition, through, for example, the content of catalyst, the reactivity of the isocyanates present, and the amount thereof. The lower limit of the pot life is the pot life that is obtained in a given composition when using a defined amount of catalyst without addition of compound T. In many situations suitable for use according to the invention as a structural adhesive or composite material matrix and as a consequence of the large number of isocyanate groups in the presence of a catalyst but without compound T, no actual pot life at all is achieved, and the composition starts to cure almost immediately on mixing the two components.

The upper limit of the adjustable pot life is accordingly the pot life that would be achieved through the uncatalyzed isocyanate-hydroxyl reaction if a catalyst is not used. Even without the use of a catalyst, this reaction will commence at some point after mixing the two components. However, the reaction without catalyst proceeds more slowly and with the development of poorer mechanical properties in the cured material.

The key advantage achieved by the two-component polyurethane composition of the invention is a system that cures and develops strength with extraordinary rapidity, while at the same time having an adequately long pot life that allows it to be processed in a user-friendly manner. This means, for example, that it is possible to conduct filling operations even over relatively large surface areas, which can already be ground or sanded after a very short time after the application of the filling compound. This results, for example, in a significant shortening of throughput times in industrial production. A further advantage of the polyurethane compositions of the invention is the possibility of being able to adjust the pot life as described above. This is very advantageous particularly in automated applications and can for example allow further optimization of throughput times in industrial production, since the pot life can be tailored to the desired use.

The second component B comprises firstly at least one polyisocyanate I.

The polyisocyanate I is present in relatively high amounts, which is very advantageous for the development of mechanical properties that are good enough for use as a filling compound, especially for wood.

The second component preferably contains sufficient polyisocyanate I for there to be at least 5% by weight, especially at least 6% by weight, preferably at least 7.5% by weight, of isocyanate groups based on the overall polyurethane composition.

The polyisocyanates I used for the production of the polyurethane polymer in the composition of the invention may be any commercially available polyisocyanates suitable for polyurethane production, especially diisocyanates.

Suitable polyisocyanates are in particular monomeric di- or triisocyanates and also oligomers, polymers, and derivatives of monomeric di- or triisocyanates, and any desired mixtures thereof.

Suitable aromatic monomeric di- or triisocyanates are especially tolylene 2,4- and 2,6-diisocyanate and any desired mixtures of these isomers (TDI), diphenylmethane 4,4′-, 2,4′-, and 2,2′-diisocyanate and any desired mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris(isocyanatomethyl)benzene, tris(4-isocyanatophenyl)methane, and tris(4-isocyanatophenyl) thiophosphate.

Suitable aliphatic monomeric di- or triisocyanates are in particular tetramethylene 1,4-diisocyanate, 2-methylpentamethylene 1,5-diisocyanate, hexamethylene 1,6-diisocyanate (HDI), 2,2,4- and 2,4,4-trimethylhexamethylene 1,6-diisocyanate (TMDI), decamethylene 1,10-diisocyanate, dodecamethylene 1,12-diisocyanate, lysine diisocyanate and lysine ester diisocyanate, cyclohexane 1,3- and 1,4-diisocyanate, 1-methyl-2,4- and -2,6-diisocyanatocyclohexane and any mixtures of these isomers (HTDI or H₆TDI), 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3- and 1,4-diisocyanate (m- and p-TMXDI) and bis(1-isocyanato-1-methylethyl)naphthalene, dimer and trimer fatty acid isocyanates such as 3,6-bis(9-isocyanatononyl)-4,5-di-(1-heptenyl)cyclohexene (dimeryl diisocyanate), and α,α,α′,α′,α″,α″-hexamethyl-1,3,5-mesitylene triisocyanate.

Preference among these is given to MDI, TDI, HDI, and IPDI.

Suitable oligomers, polymers, and derivatives of the recited monomeric di- and triisocyanates are especially those derived from MDI, TDI, HDI, and IPDI. Particularly suitable among these are commercially available grades, especially HDI biurets such as Desmodur® N 100 and N 3200 (from Covestro), Tolonate® HDB and HDB-LV (from Vencorex), and Duranate® 24A-100 (from Asahi Kasei); HDI isocyanurates such as Desmodur® N 3300, N 3600, and N 3790 BA (all from Covestro), Tolonate® HDT, HDT-LV, and HDT-LV2 (from Vencorex), Duranate® TPA-100 and THA-100 (from Asahi Kasei), and Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/100 (from Evonik); TDI oligomers such as Desmodur® IL (from Covestro); and also mixed isocyanurates based on TDI/HDI, for example as Desmodur® HL (from Covestro). Also particularly suitable are MDI forms that are liquid at room temperature (so-called “modified MDI”), which are mixtures of MDI with MDI derivatives such as, especially, MDI carbodiimides or MDI uretonimines or MDI urethanes, known under trade names such as Desmodur® CD, Desmodur® PF, Desmodur® PC (all from Covestro) or Isonate® M 143 (from Dow), and mixtures of MDI and MDI homologs (polymeric MDI or PMDI), available under trade names such as Desmodur® VL, Desmodur® VL50, Desmodur® VL R10, Desmodur® VL R20, Desmodur® VH 20 N, and Desmodur® VKS 20F (all from Covestro), Isonate® M 309, Voranate® M 229 and Voranate® M 580 (all from Dow) or Lupranat® M 10 R (from BASF). The abovementioned oligomeric polyisocyanates are in practice typically mixtures of substances having different degrees of oligomerization and/or chemical structures. They preferably have an average NCO functionality of 2.1 to 4.0.

The polyisocyanate is preferably selected from the group consisting of MDI, TDI, HDI, and IPDI, and oligomers, polymers, and derivatives of the recited isocyanates, and mixtures thereof.

The polyisocyanate preferably contains isocyanurate, iminooxadiazinedione, uretdione, biuret, allophanate, carbodiimide, uretonimine or oxadiazinetrione groups.

Particular preference as the polyisocyanate is given to MDI forms that are liquid at room temperature. These are especially what are called polymeric MDI, and MDI containing proportions of oligomers or derivatives thereof. The content of MDI (=diphenylmethane 4,4′-, 2,4′- or 2,2′-diisocyanate and any desired mixtures of these isomers) in such liquid MDI forms is in particular 50% to 95% by weight, in particular 60% to 90% by weight.

Particularly preference as the polyisocyanate is given to polymeric MDI and MDI grades that are liquid at room temperature and contain proportions of MDI carbodiimides or adducts thereof.

With these polyisocyanates, particularly good processing properties and particularly high strengths are obtained.

The polyisocyanate of the second component may contain proportions of polyurethane polymers having isocyanate groups. Either the second component may include a polyurethane polymer having isocyanate groups that was produced separately, or the polyisocyanate has been mixed with at least one polyol, especially a polyether polyol, with the isocyanate groups present in a stoichiometric excess over the OH groups.

In the composition according to the invention, polyisocyanate I is preferably present in an amount from 10% by weight to 50% by weight, in particular from 15% by weight to 45% by weight, particularly preferably from 20% by weight to 35% by weight, based on the overall composition.

The first component A and/or the second component B further comprises at least one metal catalyst K for the reaction of hydroxyl groups and isocyanate groups that is able to form thio complexes. Suitable metal catalysts K are thus all metal catalysts that may be used as a crosslinking catalyst in polyurethane chemistry and can at the same time form thio complexes with thiols in the presence thereof.

The metal catalyst K is preferably present only in the first component A. This has the advantage of achieving better storage stability.

Examples of suitable metal catalysts are compounds of bismuth, zinc, tin or zirconium, including complexes and salts of these metals.

The metal catalyst K preferably includes a bismuth compound, especially a bismuth(III) compound. In addition to the desired properties as a catalyst able to form thio complexes, a bismuth compound has the advantage of low acute toxicity.

A multiplicity of conventional bismuth catalysts may be used as the bismuth compound. Examples are bismuth carboxylates, for example bismuth acetate, oleate, octoate or neodecanoate, bismuth nitrate, bismuth halides such as the bromide, chloride, or iodide, bismuth sulfide, basic bismuth carboxylates such as bismuthyl neodecanoate, bismuth subgallate or bismuth subsalicylate, and mixtures thereof.

In a preferred embodiment, the metal catalyst K is a bismuth(III) complex containing at least one ligand based on 8-hydroxyquinoline. Such complexes are described in EP 1551895. This is preferably a bismuth(III) carboxylate containing one molar equivalent of an 8-hydroxyquinoline ligand.

In a further preferred embodiment, the metal catalyst K is a bismuth(III) complex containing at least one ligand based on a 1,3-ketoamide. Such complexes are described in EP 2791153. This is preferably a bismuth(III) carboxylate containing 1 to 3 molar equivalents of a 1,3-ketoamide ligand.

The composition according to the invention further comprises between 3% and 25% by weight, preferably between 4% and 20% by weight, more preferably between 5% and 20% by weight, based on the total composition, of at least one type of hollow microsphere H.

The hollow microspheres H used have a compressive strength, measured in accordance with ASTM D3102-72, of at least 10 MPa, preferably at least 15 MPa. The compressive strength can be determined in accordance with ASTM D3102-72. A detailed method for the measurement of the preferred hollow microspheres H based on this industry standard can be found in WO 2012/033810, p. 15, second paragraph.

When hollow microspheres H having a compressive strength of below 10 MPa are used, not only does this adversely affect the pumpability and the stability of the density after pumping in the production or conveying of the composition, but it also surprisingly results in a material having lower strength, a rougher surface, poorer grindability and poorer application properties. It is thus essential to the invention that hollow microspheres H having a compressive strength of at least 10 MPa are used.

In addition, the hollow microspheres H have a density (bulk density) of at least 0.2 kg/L, preferably at least 0.3 kg/L, especially at least 0.4 kg/L. When hollow beads having lower density are used, the strength of the composition is too low, and the hardness and surface characteristics of the cured composition no longer meet the demands as filling compound, especially as wood filling compound. Preferably, the hollow microspheres H have a median particle size (volume-based median D50) of not more than 60 μm, preferably not more than 45 μm, especially not more than 30 μm, measured by laser diffraction. Such hollow beads create a surface of particularly good grindability on the cured composition which is of particularly good suitability for filling compounds, and which has a particularly smooth, uniform surface after grinding. When hollow spheres having a much greater particle size are used, for example exceeding 200 μm, it may be the case that the surface is uneven after grinding.

The hollow microspheres H are essentially spherical bodies comprising a shell and a gas in the inner cavity. The gas may, for example, be air, CO₂, nitrogen, oxygen, hydrogen, a noble gas or mixtures of said gases. The shell may be made, for example from, glass, in particular borosilicate glass, silicates, in particular aluminosilicate, or from polymers, in particular thermoplastic polymers.

The hollow microspheres H are preferably made of glass, especially borosilicate glass, and the hollow microspheres H are preferably white or colorless. As well as ideal mechanical properties, these also enable various colors of the polyurethane composition, which is advantageous in the case of visible filling for esthetic reasons.

Suitable hollow microspheres H made of glass and the production thereof are taught for example in U.S. Pat. No. 8,261,577 and WO 2012/033810.

Preferred suitable, commercially available hollow microspheres H made of glass are 3M™ Glass Bubbles, available from 3M Deutschland GmbH. Particular preference is given to the S60, K37, iM16K and S28HS products.

The hollow microspheres H are preferably in component B. In this case, component B contains preferably 6% to 50% by weight, preferably 7% to 40% by weight, especially 8% to 30% by weight, of hollow microspheres H, based on component B.

The composition according to the invention further comprises between 2.5% and 7.5% by weight, preferably between 3% and 6% by weight, based on the overall composition, of at least one type of hollow desiccant D, where the desiccant D is an aluminosilicate.

The desiccant D is important especially for use as a wood filling compound or on other moisture-containing substrates, since residual moisture in the wood, for example, can disrupt the curing of the polyurethane composition and leads to blistering or inadequate curing, particularly in thin layers. It has been found experimentally that, surprisingly, only aluminosilicate desiccants are suitable for the present invention. Reactive silanes or isocyanates as otherwise used as desiccants in polyurethane compositions lead to a deterioration in pot life during application and/or in grindability after curing.

It is likewise necessary for at least 2.5% of desiccant D, based on the overall polyurethane composition, to be present in order to obtain desired processibility and grindability. An amount exceeding 7.5% by weight, based on the overall composition, shortens the pot life and is therefore not recommended.

Suitable desiccants D are all aluminosilicates usable as desiccants, for example molecular sieves or zeolites.

The desiccant D is preferably a molecular sieve having a pore size of at least 2.5 Å.

The desiccant D is preferably in component B. In this case, component B contains preferably 5% to 15% by weight, preferably 8% to 14% by weight, especially 9% to 13% by weight, of desiccants D, based on component B.

Preferred further constituents are inorganic or organic fillers, such as, in particular, natural, ground or precipitated calcium carbonates, optionally coated with fatty acids, in particular stearic acid, baryte (heavy spar), talcs, quartz powders, quartz sand, dolomites, wollastonites, kaolins, calcined kaolins, mica (potassium aluminum silicate), aluminum oxides, aluminum hydroxides, magnesium hydroxide, silicas including finely divided silicas from pyrolysis processes and hydrophobized variants thereof, industrially produced carbon blacks, graphite, metal powders such as aluminum, copper, iron, silver or steel, PVC powder or hollow spheres, and also flame-retardant fillers such as hydroxides or hydrates, in particular hydroxides or hydrates of aluminum, preferably aluminum hydroxide.

The addition of fillers is advantageous in that it increases the strength of the cured polyurethane composition.

The polyurethane composition preferably comprises at least one filler selected from the group consisting of calcium carbonate, carbon black, kaolin, baryte, talc, quartz powder, dolomite, wollastonite, kaolin, calcined kaolin, and mica.

Particularly preferred as fillers are ground calcium carbonates, calcined kaolins or carbon black.

It may be advantageous to use a mixture of different fillers. Most preferred are combinations of ground calcium carbonates or calcined kaolins and carbon black.

The content of filler F in the composition is preferably within a range from 5% by weight to 50% by weight, especially 10% by weight to 40% by weight, more preferably 15% by weight to 30% by weight, based on the overall composition.

It is possible for further constituents to be additionally present, especially solvents, plasticizers and/or extenders, pigments, rheology modifiers such as, in particular, amorphous silicas, desiccants such as, in particular, zeolites, adhesion promoters such as, in particular, organofunctional trialkoxysilanes, stabilizers against oxidation, heat, light, and UV radiation, flame-retardant substances, and also surface-active substances, especially wetting agents and defoamers.

The polyurethane composition contains preferably less than 0.5% by weight, especially less than 0.1% by weight, based on the overall composition, of carboxylic acids, since these can impair curing. Any carboxylate ligands introduced through the metal catalyst are not included here among said carboxylic acids.

A preferred polyurethane composition comprises a first component A that, based in each case on component A, comprises
30% to 90% by weight, preferably 40% to 80% by weight, in particular 50% to 70% by weight, of polyol A1,
5% to 25% by weight, preferably 10% to 20% by weight, in particular 12% to 18% by weight, of diol A2,
0.25% to 5% by weight, preferably 1% to 3% by weight, especially 1.5% to 2% by weight, of a compound T having at least one thiol group,
0.05% to 2% by weight, preferably 0.1% to 1.5% by weight, in particular 0.3% to 1% by weight, of a metal catalyst K, and
10% to 50% by weight, preferably 15% to 40% by weight, especially 20% to 30% by weight, of fillers,
   and optionally further constituents.

Another preferred polyurethane composition comprises a second component B that, based in each case on component B, comprises
30% to 80% by weight, preferably 40% to 70% by weight, especially 50% to 70% by weight, of polyisocyanate I,
5% to 15% by weight, preferably 8% to 14% by weight, especially 9% to 13% by weight, of desiccants D,
6% to 50% by weight, preferably 7% to 40% by weight, especially 8% to 30% by weight, of hollow microspheres H, and
0% to 40% by weight, preferably 10% to 30% by weight, especially 15% to 25% by weight, of fillers,
   and optionally further constituents.

A preferred two-component polyurethane composition consists of the two preferred components A and B just mentioned.

The first and second components, in all embodiments, are advantageously formulated such that the mixing ratio thereof in parts by weight is in the range from 5:1 to 1:5, preferably between 3:1 and 1:3, more preferably between 2:1 and 1:2.

The first and second components, in all embodiments, are advantageously formulated such that the mixing ratio thereof in parts by volume is in the range from 5:1 to 1:5, preferably between 3:1 and 1:3, more preferably between 2:1 and 1:2.

In the mixed polyurethane composition, the molar ratio before curing between the number of isocyanate groups and the number of isocyanate-reactive groups, especially hydroxyl groups of the polyols, is in the range of 0.9:1-1.4:1, preferably 1.05:1-1.3:1.

The polyurethane composition, directly after mixing of components A and B, is preferably free-flowing, especially self-leveling, at 23° C. This means that it can be used as an automatically cavity-filling composition, and is able to fill cavities completely or virtually completely. It is possible and may be advisable for the composition to be slightly thixotropic. In some preferred embodiments, the composition is self-levelling after mixing.

The polyurethane composition, directly after mixing of components A and B, preferably has a viscosity, measured at 20° C. on a plate-plate viscometer with plate separation 1 mm and plate diameter 25 mm, of <5000 Pa·s, preferably <4000 Pa·s, at a shear rate of 0.01 s⁻¹, and of <500 Pa·s, preferably <200 Pa·s, at a shear rate of 1 s⁻¹, and of <50 Pa·s, preferably <30 Pa·s, at a shear rate of 10 s⁻¹.

The viscosity can be adjusted by routine tests via formulation measures, for example the selection of the polyols and/or fillers and the use of low-viscosity additions such as plasticizers.

The two components are produced separately and preferably with the exclusion of moisture. The two components are typically each stored in a separate container. The further constituents of the polyurethane composition may be present as a constituent of the first or second component, further constituents that are reactive toward isocyanate groups preferably being a constituent of the first component. A suitable container for storing the respective component is especially a drum, a hobbock, a bag, a bucket, a can, a cartridge or a tube. The components are both storage-stable, meaning that they can be stored prior to use for several months up to one year or longer without any change in their respective properties to a degree relevant to their use.

The two components are stored separately prior to the mixing of the composition and are not mixed with one another until use or just before use. They are advantageously present in a package consisting of two separate chambers.

In a further aspect, the invention comprises a pack consisting of a package having two separate chambers which respectively contain the first component and the second component of the composition.

Mixing is typically effected via static mixers or with the aid of dynamic mixers. During mixing, great care must be taken to ensure that the two components are mixed as homogeneously as possible. If the two components are mixed incompletely, local deviations from the advantageous mixing ratio can occur, which can result in a deterioration in the mechanical properties.

On contact of the first component with the second component, after the latency period of the catalyst resulting from the reaction with the thiols of the compound T, the curing commences through chemical reaction. This involves the reaction with the isocyanate groups of the hydroxyl groups and any other substances present that are reactive toward isocyanate groups. Excess isocyanate groups react predominantly with moisture. As a result of these reactions, the polyurethane composition cures to give a solid material. This process is also referred to as crosslinking.

The invention thus also further provides a cured polyurethane composition obtained from the curing of the polyurethane composition as described in the present document.

Thus, the polyurethane composition described is advantageously usable as filling compound, especially as filling compound for the filling of gaps, cavities, holes, fissures and joins, especially for wood.

The polyurethane composition is further preferably used as a filling compound, especially as a wood filling compound. In a further aspect, the invention therefore encompasses the use of a two-component polyurethane composition as filling compound, especially as filling compound for smoothing the surface of wood.

In a further aspect, the invention therefore encompasses a method of smoothing a surface by filling cavities, fissures, holes and gaps in a substrate, especially a wood substrate, comprising the steps of
a) mixing the first component A and the second component B of a two-component polyurethane composition as described above,
b) filling the cavities, fissures, holes or gaps to be filled on the surface of the substrate with the mixed polyurethane composition within the pot life thereof;
c) optionally pressing the polyurethane composition applied in step b) onto the substrate and/or into the cavities, cracks, fissures, holes or gaps on the surface of the substrate by means of a preferably heated roller or press;
d) during the filled mixed polyurethane composition in the cavities, cracks, fissures, holes or gaps on the surface of the substrate;
e) smoothing the filled substrate surface by means of grinding, abrasion or sanding.

Step c) is optional, but is preferable, for example, for the processing of relatively large wood substrates in industrial processes. This allows the filling of the cavities, fissures, holes or gaps in the surface of the substrate to be conducted even more efficiently, and the use of a heated roller or press has the additional advantage that the composition cures even more quickly, which enables even shorter cycle times.

Suitable substrates in these methods are especially:
glass, glass ceramic, glass mineral fiber mats;
metals and alloys such as aluminum, iron, steel and nonferrous metals, and also surface-finished metals and alloys such as galvanized or chromed metals;
coated and painted substrates, such as powder-coated metals or alloys and painted sheet metal;
plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), ethylene/propylene copolymers (EPM), and ethylene/propylene/diene terpolymers (EPDM), where the plastics may preferably have been surface-treated by means of plasma, corona or flames;
fiber-reinforced plastics, such as carbon fiber-reinforced plastics (CFRP), glass fiber-reinforced plastics (GFRP) and sheet-molding compounds (SMC);
wood, including natural woods or wood treated with resins, for example phenolic, melamine or epoxy resins, bound woodbase materials, resin-textile composites and further polymer composites; and
concrete, asphalt, mortar, brick, plaster, and natural stone such as granite, limestone, sandstone or marble.

Particularly suitable substrates are concrete, natural stone, plastic, wood, glass, ceramic and fiber-reinforced plastics, especially wood and fiber-reinforced plastics. Most suitable and preferred are wood or wood-based materials, for example wood treated with resins, for example phenol, melamine or epoxy resins, bound woodbase materials, resin-textile composites and further wood-polymer composites.

After the polyurethane composition of the invention has been applied by the abovementioned method, it cures very rapidly to give a high-strength, hard-elastic material having a Shore D hardness of at least 60 and a homogeneous, dry surface.

A significant advantage of the polyurethane composition of the invention is a sufficiently long pot life, which enables problem-free application, followed by exceptionally rapid curing and grindability. This not only enables filling operations with exceptionally rapid cycle and processing times, but additionally also with exceptionally good mechanical properties.

The cycle time, particularly in automated filling processes, can be increased further, by heating the polyurethane composition applied, for example by means of a heated production line or a heated roller or press, which additionally again improves the filling of confined cavities, clefts or the like via pressure on the polyurethane composition applied. The heating actually accelerates the curing reaction, with temperatures of 40° C. to 60° C. or higher already having an accelerating effect on curing, without thermal impairment of the substrate.

After curing, the composition is grindable without difficulty, for example by sandblasting or other suitable grinding methods that are known to the person skilled in the art for all substrates. The composition is grindable in principle by any grinding technique. The substrate, preferably wood, can be abraded by the same grinding application, resulting in a smooth surface which is homogeneous with regard to compressive strength and tensile strength.

For visual or esthetic requirements, the polyurethane composition of the invention may also be colored, for example with pigments or dyes.

In a further aspect, the invention therefore also encompasses an article having a surface that has been smoothed by the method described above.

### EXAMPLES

TABLE 1
Substances used

| | |
|---|---|
| Voranol CP 4755 | Voranol ® CP 4755 (Dow Chemical); polyether triol, CAS No. |
| | 9082-00-2; MW: 5000 g/mol; OH value: 35 mg KOH/g |
| Lupranol 3422 | Lupranol ® 3422 (BASF); higher-functionality polyetherol; OH |
| | number: 490 mg KOH/g |
| Pentane-1,5-diol | (Sigma Aldrich) |
| Thiocure GDMP | Thiocure ® GDMP (Bruno Bock Thiochemicals); glycol |
| | di(3-mercaptopropionate) |
| Desmodur CD-S | Desmodur ® CD-S (Covestro); modified diphenylmethane |
| | 4,4′-diisocyanate (MDI); NCO content: 29.5% by weight |
| Glass Bubbles | 3M ™ Glass Bubbles iM16K (3M); white hollow borosilicate glass |
| iM16K | spheres; density: 0.46 kg/m³; compressive strength (ASTM |
| | D3102-72): 110.3 MPa (hollow microspheres H) |
| Sylosiv A3 | Sylosiv ® A3 (W.R: Grace); micronized molecular sieve |
| | (aluminosilicate); pore size: 3 Å (desiccant D) |
| Monarch 570 | Monarch ® 570 (Cabot Corp.); carbon black (filler) |
| Whitetex | Satintone ® W (Whitetex) (BASF); calcined kaolin (filler) |
| HDK H18 | HDK ® H18 (Wacker); hydrophobic fumed silica (filler) |
| Omyacarb 5-GU | Omyacarb ® 5-GU (Omya); ground natural chalk (filler) |
| Bi cat. (2.68 | 35% by weight of Coscat 83 (organobismuth catalyst; Coscat ® 83 |
| mmol Bi/g) | (Vertellus Specialties Inc.)) in plasticizer containing 1 molar |
| | equivalent of 8-hydroxyquinoline (based on Bi) |
| Sn cat. | dibutyltin dilaurate (Sigma Aldrich) |

Production of Polyurethane Compositions

For each composition, the ingredients of the first component A specified in table 2 were processed in the amounts specified (in parts by weight), by means of a vacuum dissolver with the exclusion of moisture, to give a homogeneous paste and stored. The ingredients of the second component B specified in the tables were likewise processed and stored. The two components were then processed for 30 seconds, by means of a SpeedMixer® (DAC 150 FV, Hauschild), into a homogeneous paste, which was immediately tested as follows:

Testing of the Example Compositions

Shore D hardness was determined to DIN 53505 on test specimens having a layer thickness of 4 mm that had been cured at 23° C. and 50% relative humidity (standard climatic conditions) for 7 days. The exact storage time (curing time) before the respective measurement is specified in table 3.

Wait time before grindable was determined by measuring the time in minutes before the surface of test specimens produced according to ASTM D4060-19 from the mixed two-component composition to be tested had dried to such an extent by curing under standard climatic conditions that it could be abraded.

Grindability after curing was assessed by subjecting the grinding outcome to visual and tactile assessment. Smooth, dry, sufficiently hard and homogeneously ground surfaces were classified as “very good”. In the case of non-ideal results (observed inhomogeneities or insufficient hardness), the assessment was correspondingly classified as “good”, “poor” or “very poor”.

Pot life was measured in a viscometer as the time until the viscosity began to rise steeply after the two components had been mixed. Viscosity was measured on an MCR 302 parallel-plate rheometer (Anton Paar) with a plate diameter of 25 mm and a plate distance of 1 mm at a frequency of 0.1 s⁻¹ and a temperature of 20° C. This was done by first mixing the two components for 30 sec in a SpeedMixer (Hauschild) and immediately applying them to the plates for the measurement.

TABLE 2
Produced example compositions C-1 to C-4.

| | | | | |
|---|---|---|---|---|
| Example | C-1 (ref.) | C-2 (ref.) | C-3 | C-4 (ref.) |

First component A (amounts in parts by weight)

| | | | | |
|---|---|---|---|---|
| Voranol CP 4755 | 50.5 | 50.5 | 50.5 | 50.5 |
| Lupranol 3422 | 3.0 | 3.0 | 3.0 | 3.0 |
| Pentane-1,5-diol | 17.0 | 17.0 | 17.0 | 17.0 |
| Thiocure GDMP | 2.4 | 2.4 | 2.4 | 2.4 |
| Bi cat. (2.68 mmol Bi/g) | 0.6 | 0.6 | 0.6 | 0.6 |
| HDK H18 | 6.0 | 6.0 | 6.0 | 6.0 |
| Omyacarb 5-GU | 20.5 | 20.5 | 20.5 | 20.5 |
| TOTAL | 100 | 100 | 100 | 100 |

Second component B (amounts in parts by weight)

| | | | | |
|---|---|---|---|---|
| Desmodur CD-S | 60.0 | 60.0 | 60.0 | 60.0 |
| HDK H18 | 6.0 | 6.0 | 6.0 | 6.0 |
| Monarch 570 | 4.0 | 4.0 | 4.0 | 4.0 |
| Whitetex | 17.5 | 20.0 | 7.5 | 30.0 |
| Glass Bubbles iM16K | 12.5 | — | 12.5 | — |
| Sylosiv A3 | — | 10.0 | 10.0 | — |
| TOTAL | 100 | 100 | 100 | 100 |

Mixture of A and B

| | | | | |
|---|---|---|---|---|
| Mixing ratio (volume) of | 1:1 | 1:1 | 1:1 | 1:1 |
| A:B | | | | |

TABLE 3
Properties of the example compositions and suitability as wood filling compound.

| Composition | C-1 (ref.) | C-2 (ref.) | C-3 | C-4 (ref.) |
|---|---|---|---|---|
| Pot life | Shortened | Prolonged | Optimal and | Optimal and |
| (processing time) | | | adjustable | adjustable |
| Surface after curing | Hard, tacky in | Soft and dry | Hard and dry | Soft, tacky in |
| | thin layers | | | thin layers |
| Grindability after | Good | Poor | Very good | Very poor |
| curing | | | | |
| Wait time before | 35 min | 23 min | 23 min | 35 min |
| grindable | | | | |
| Shore D hardness | 62 | 40 | 60 | 25 |

Table 3 shows that only composition C-3 has sufficiently high hardness, a sufficiently long and adjustable pot life and a sufficiently short wait time before being grindable. Moreover, it has very good grindability.

Although composition C-4 has very good applicability (long, adjustable plot life), grindability and wait time before grindable are poor, and the material is too soft after curing.

Composition C-1 has good grindability and good hardness. However, the wait time before grindable is too long, and application is impaired because of shortened pot life.

Composition C-2 has an unfavorable extension of pot life, which impairs cycle times, and the composition is too soft after curing and has poor grindability.

Comparative Experiments with Other Desiccants and Other Hollow Microspheres.

A number of compositions were produced, with the intention of showing the effect of the desiccants D of the invention and of hollow microspheres H.

Composition C-5 (Ref.)

Composition C-5 corresponds to composition C-3 as described above, with the sole difference that, rather than Sylosiv A3, 10 parts by weight of Dynasylan® A (tetraethoxysilane; from Evonik) was used as desiccant in component B. By comparison with composition C-3, pot life was shortened in C-5, and wait time before grindable was extended to 30 min.

Composition C-6 (Ref.)

Composition C-6 corresponds to composition C-3 as described above, with the sole difference that, rather than Sylosiv A3, 10 parts by weight of calcium oxide was used as desiccant in component B. By comparison with composition C-3, pot life was shortened significantly in C-6, and the material was no longer processible.

Composition C-7 (Ref.)

Composition C-7 corresponds to composition C-3 as described above, with the sole difference that, rather than Glass Bubbles iM16K, 12.5 parts by weight of Omyasphere® 220 (density: 0.27 kg/L; compressive strength (ASTM D3102-72): 2.5 MPa; from Omya) was used as hollow microspheres in component B. By comparison with composition C-3, composition C-7 showed a rough, poorly grindable surface after curing.

1. A polyurethane composition consisting of a first component A and a second component B; wherein
the first component A comprises
at least one polyol A1 having an OH functionality in the range from 1.5 to 4 and a mean molecular weight (number average) Mn, measured by means of GPC against polystyrene, in the range from >500 to 15'000 g/mol, and
at least one polyol A2 having an OH functionality in the range from 2 to 6 and a mean molecular weight (number average) Mn, measured by means of GPC against polystyrene, in the range from 50 to 500 g/mol, and
at least one compound T having at least one thiol group; and
the second component B comprises
at least one polyisocyanate I;
wherein one of the components additionally comprises at least one metal catalyst K for the reaction of hydroxyl groups and isocyanate groups that is able to form thio complexes;
and wherein the molar ratio of all the thiol groups in the at least one compound T to all metal atoms in the at least one metal catalyst K is between 1:1 and 250:1;
and wherein the molar ratio of all NCO groups in the polyisocyanates I to all OH groups in the polyols A1 and A2=0.9:1-1.4:1;
and wherein the composition, in at least one of the two components, contains between 3% and 25% by weight, based on the overall composition, of at least one type of hollow microspheres H, where the hollow microspheres H have a compressive strength measured to ASTM D3102-72 of at least 10 MPa and a density of at least 0.2 kg/L;
and wherein the composition, in at least one of the two components, contains between 2.5% and 7.5% by weight, based on the overall composition, of at least one desiccant D, where the desiccant D is an aluminosilicate.

2. The polyurethane composition as claimed in claim 1, wherein the metal catalyst K comprises a bismuth(III) compound.

3. The polyurethane composition as claimed in claim 1, wherein the diol A2 is selected from the group consisting of butane-1,3-diol, butane-1,4-diol, butane-2,3-diol, 2-methylpropane-1,3-diol, pentane-1,2-diol, pentane-2,4-diol, 2-methylbutane-1,4-diol, 2,2-dimethylpropane-1,3-diol, hexane-1,2-diol, 3-methylpentane-1,5-diol, octane-1,2-diol, octane-3,6-diol, 2-ethylhexane-1,3-diol, 2,2,4-trimethylpentane-1,3-diol, 2-butyl-2-ethylpropane-1,3-diol, 2,7-dimethyloctane-3,6-diol, cyclohexane-1,4-diol, cyclohexane-1,3-dimethanol and cyclohexane-1,4-dimethanol.

4. The polyurethane composition as claimed in claim 1, wherein the at least one compound T comprises a polythiol compound having 2 to 6 thiol groups, or a mercaptosilane.

5. The polyurethane composition as claimed in claim 4, wherein the at least one compound T is selected from the group consisting of ethylene glycol di(3-mercaptopropionate), 1,8-dimercapto-3,6-dioxaoctane, ethylene glycol dimercaptoacetate, dipentaerythritol hexa(3-mercaptopropionate), and 3-mercaptopropyltrimethoxysilane.

6. The polyurethane composition as claimed in claim 1, wherein the molar ratio of all the thiol groups in the at least one compound T to all metal atoms in the at least one metal catalyst K is between 5:1 and 100:1.

7. The polyurethane composition as claimed in claim 1, wherein the metal catalyst K is present in the first component A.

8. The polyurethane composition as claimed in claim 1, wherein the polyol A1 comprises at least one polyether polyol.

9. The polyurethane composition as claimed in claim 1, wherein the polyisocyanate I is a form of diphenylmethane 4,4′-, 2,4′- or 2,2′-diisocyanate that is liquid at room temperature or any desired mixtures of these isomers (MDI) in the form of polymeric MDI or MDI containing proportions of oligomers or derivatives.

10. The polyurethane composition as claimed in claim 1, wherein the second component B comprises a polyurethane polymer containing isocyanate groups.

11. The polyurethane composition as claimed in claim 1, wherein the hollow microspheres H comprise hollow glass be beads.

12. The polyurethane composition as claimed in claim 1, wherein the desiccant D comprises a molecular sieve having a pore size of at least 2.5 Å.

13. The polyurethane composition as claimed in claim 1, wherein the mixing ratio in parts by volume between the first and second components is in the range from 5:1 to 1:5.

14. A method of smoothing a wood surface comprising:
obtain or prepare a polyurethane composition as recited in claim 1 to use as a filling compound;
smooth the wood surface by applying the filling compound.

15. A method of smoothing a surface by filling cavities, fissures, holes and gaps in a substrate, comprising the steps of
a) mixing the first component A and second component B of a two-component polyurethane composition as claimed in claim 1,
b) filling the cavities, fissures, holes or gaps to be filled on the surface of the substrate with the mixed polyurethane composition within the pot life thereof;
c) optionally pressing the polyurethane composition applied in step b) onto the substrate and/or into the cavities, cracks, fissures, holes or gaps on the surface of the substrate by means of a heated roller or press;
d) during the filled mixed polyurethane composition in the cavities, cracks, fissures, holes or gaps on the surface of the substrate;
e) smoothing the filled substrate surface by means of grinding, abrasion or sanding.
